(19) United States
(12) Patent Application Publication
(10) Pub. No.: US 2012/0142239 A1
(43) Pub. Date: Jun. 7, 2012

(54) Elastomer Composition

(76) Inventors: Graham Budden, Cowbridge (GB); Dimitra Domvoglou, Cardiff (GB)

(21) Appl. No.: 13/141,516

(22) PCT Filed: Dec. 23, 2009
(86) PCT No.: PCT/EP2009/067856

§ 371 Date: Sep. 27, 2011

(30) Foreign Application Priority Data
Dec. 23, 2008 (GB) GB0823431.2
Dec. 23, 2009 (EP) PCT/EP2009/067856

(51) Int. Cl. B32B 25/20; B32B 5/18; C09D 175/04; B32B 25/10; C09D 183/04; C09D 183/07

(52) U.S. Cl. 442/59; 524/588; 524/500; 524/590; 521/154; 521/170; 428/319.3; 428/221

(57) ABSTRACT

This invention relates to a composition comprising a mixture of: (A) an elastomeric material having a modulus at 100% elongation of 0.1-10 MPa; and (B) a non-reactive silicone fluid having a viscosity of 1,000-3,000,000 mPas at 25° C. The elastomer is preferably a silicone elastomer. The invention also provides an impact-resistant material comprising the composition and a shaped article, e.g. a moulded article, made therefrom. The composition provides impact resistance.

This invention relates to an elastomer composition and in particular to an elastomer composition which acts as an energy-absorbing material in order to provide impact resistance.

The presently available impact-protection materials tend to fall into two categories, namely a rigid exterior shell which can be uncomfortable to wear (e.g. knee or elbow protectors) or foam pads (e.g. inserts for clothing) which provide poor levels of protection and are often not comfortable to wear. Energy-absorbing materials have therefore been proposed which combine the protection of rigid shells and the flexibility of foam pads.

Energy-absorbing materials find wide application, for example in protective garments for potentially dangerous sports such as motorcycling, skiing, skating, skateboarding or snowboarding, and as protective packaging materials. Typically, energy-absorbing materials are formed into sheets, which may then be further processed into shaped articles formed partially or completely from the sheet material. The sheet material may be formed from energy-absorbing material per se, or the sheet may be formed from substrate, such as a fabric or a foam impregnated with the energy-absorbing material. It is possible, however, to provide energy absorbing materials as pre-shaped objects, for example through molding or in-situ-formation processes.

By way of an example, WO 03/022085 describes a flexible energy absorbing material in which a dilatant (shear thickening) material is impregnated into a flexible carrier such as a fabric or foam. The dilatant material remains soft until it is subjected to an impact, when its characteristics change rendering it temporarily rigid. The dilatant material returns to its normal flexible state after the impact. The preferred dilatant material is a silicone composition available from Dow Corning as “Dow Corning® 3179”. The flexible energy absorbing material may be worn as impact protection, for example as clothing or as knee or elbow pads. FR2712487 describes a shock-absorbing material for cushioning the sole of the foot, produced by crosslinking a silicone composition, optionally after incorporating a reinforcement system comprising a flexible woven or thermo-bonded mesh or long reinforcing fibres. GB227350 describes a silicone elastomer obtainable by condensation of polydimethyl and/or methylhydrosiloxanediols with a methylphenylsilicone polymer in the presence of reactive compounds of silicon, boron or nitrogen. The preferred reactive compound used in the examples being boron hydroxide used to boronate the composition. The final product is advocated as a mechanical energy absorber.

The use of unreactive silicones as plasticisers (sometimes referred to as extenders or process aids) is well known in silicone sealant materials such as discussed in WO2006/106359 and EP0842974. EP0942046 describes the use of an unreactive silicone as an additive in a mold making material. However, none of these cases advocate or even suggest the potential for using such a material as an impact resistant material as described herein.

However, there remains a need in the art for flexible energy-absorbing materials which can absorb great amounts of energy without compromising flexibility.

Accordingly, the present invention provides a composition comprising a mixture of: (A) an elastomeric material having a modulus at 100% elongation of 0.1-10 MPa; and (B) a substantially non-reactive silicone fluid having a viscosity of 1,000-3,000,000 mPas at 25° C.

In a preferred embodiment, the present invention provides Use of a composition comprising a mixture of:
(A) an elastomeric material having a modulus at 100% elongation of 0.1-10 MPa; and
(B) 5-80% by weight, based on the total weight of the composition of a non-reactive silicone fluid having a viscosity of 1,000-3,000,000 mPas at 25° C.;
   in or as an impact-resistant material.

This combination of components provides an excellent balance of flexibility and energy-absorption.

Component A is an elastomeric material having a modulus at 100% elongation of 0.1-10 MPa. Preferably the modulus at 100% elongation is 0.5-9 MPa. The modulus at 100% elongation may be determined by the process described in ASTM D638-97. However, some elastomers cannot be elongated to 100% and in such cases the modulus may be determined at lower elongation values and extrapolated to 100%.

The elastomeric material may be a natural elastomer, such as a latex rubber, or a synthetic elastomer. Examples of suitable synthetic elastomers include neoprene; polyester; polyurethane, such as Witcoflex 959 Matt from Baxenden Chemicals Ltd which is a solvent-based single component polyurethane solution in isopropanol and toluene and has a modulus at 100% elongation of 3.5 MPa; ethylene/vinyl acetate copolymer (EVA); EP rubbers such as EPDM rubbers; or copolymers including those having an olefin block, such as polypropylene or an ethylene in conjunction with softer blocks. Such elastomeric materials can be provided a polymers in bead form which may be melt-processable, provided in solution or provided in emulsion, or they may be provided a precursors which are then reacted with other ingredients, for example where the material is a polyurethane precursor, they may be reacted with isocyanates. These elastomeric materials may also be cross-linked, for example polyurethanes cross-linked using hydroxy and/or amine terminated cross-linking agents. Preferably the elastomeric materials are a non-thermoplastic elastomer.

More preferably, however, the elastomeric material is a siloxane material, in which case the elastomer is formed by cross-linking a siloxane polymer material, or polyorganosiloxane. Preferably borated silicone polymers are excluded from component A, in particular those exhibiting dilatant properties. The polymer and the cross-linking conditions are not critical, provided that the cured cross-linked elastomer formed has the required modulus at 100% elongation. Examples of the cross-linking (curing) reactions include: cross-linking a polyorganosiloxane having alkenyl or alkynyl functional groups and a polyorganohydrogensiloxane in the presence of a hydrosilylation catalyst (a platinum-type catalyst) and cross-linking α,ω-dihydroxypolydiorganosiloxane with a hydrolysable group-containing organosilane in the presence of a condensation catalyst. Other cure systems such as cross-linking a polyorganosiloxane having alkenyl or alkynyl functional groups in the presence of an organic peroxide catalyst may be used but are not preferred. This is because peroxide type catalysts function via a free-radical reaction pathway (i.e. free radical initiated) and may potentially lead to the cross-linking of components A and B of the composition described herein.

In one embodiment, the elastomer is obtained from a curable silicone elastomer-forming composition based on a polyorganosiloxane having alkenyl or alkynyl functional groups and a polyorganohydrogensiloxane in the presence of a hydrosilylation catalyst (a platinum-type catalyst). Such curable silicone elastomer-forming composition comprises (i) an organopolysiloxane polymer having at least two alkenyl or alkynyl groups per molecule, preferably at least one of which is and most preferably at least two of which are end group(s) and optionally alkenyl or alkynyl groups linked to silicon atoms along the polymer backbone, preferably (ii) a filler, typically treated with a hydrophobing agent, and (iii) a cure package having a siloxane cross-linker containing at least three Si—H groups per molecule and a hydrosilylation catalyst.

In the case of the curable silicone elastomer-forming composition being a liquid silicone rubber (LSR) composition, the organopolysiloxane polymer comprises one or more polymers having the formula:

R_{(3-z)}R¹₂SiO[(R₂SiO)ₓ(R¹SiO)_{y}]SiR_{(3-z)}R¹₂

wherein each R is the same or different and represents a C₁₋₆ alkyl group, an aryl (e.g. phenyl or naphthyl) group or a fluoro-C₁₋₆ alkyl group, preferably each R group is a methyl or ethyl group; R¹ is a C₂₋₆ alkenyl group or an alkynyl group, preferably a vinyl or hexenyl group; x is an integer and y is zero or an integer and x+y is a number (e.g. 100-1000) such that the polymer has a viscosity at 25° C. of 50-250,000 mPas, preferably 100-100,000 mPas, as measured for example by a Brookfield Rotational Viscometer (which technique is applicable to all viscosity measurements referred to in the specification, unless otherwise indicated).

The curable silicone elastomer-forming composition may also be a diluted high consistency rubber (HCR) which is based on the same formula as the LSR but the starting viscosity of the polymer is greater than 250,000 mPas at 25° C., more usually greater than 500,000 mPas at 25° C. and typically greater than 1,000,000 mPas at 25° C. The upper limit may be many millions. There is nothing preventing the use of an organopolysiloxane polymer with a viscosity below 250,000 mPas at 25° C. in the present invention, but these would be considered an LSR rather than a HCR.

Because a HCR is usually in the form of a gum-like material which has such high viscosity that the measurement of viscosity is extremely difficult, HCRs are often referred by reference to their Williams plasticity number (ASTM D926). The Williams plasticity number of high viscosity polysiloxane gum-like polymers are generally at least 30, typically they are in the range of from about 30 to 250. The plasticity number, as used herein, is defined as the thickness in millimetres×100 of a cylindrical test specimen 2 cm³ in volume and approximately 10 mm in height after the specimen has been subjected to a compressive load of 49 Newtons for three minutes at 25° C. These polysiloxane gum-like polymers generally contain a substantially siloxane backbone (—Si—O—) to which are linked alkyl groups such as for example methyl, ethyl, propyl, isopropyl and t-butyl groups, and unsaturated groups for example alkenyl groups such as allyl, 1-propenyl, isopropenyl, or hexenyl groups but vinyl groups are particularly preferred and/or combinations of vinyl groups and hydroxyl groups to assist in their cross-linking. Such polysiloxane gum-like polymers typically have a degree of polymerisation (DP) of 500-20,000, which represents the number of repeating Si—O units in the polymer. Although an HCR may be used, an LSR is preferred as the viscosity is more manageable.

The LSR and HCR compositions discussed above are usually cross-linked with an organohydrogensiloxane in the presence of a hydrosilylation reaction catalyst. To effect curing where the alkenyl or alkynyl containing polymers have on average no more than 2 alkenyl or alkynyl groups, the organohydrogensiloxane must contain more than two silicon-bonded hydrogen atoms per molecule, preferably 4-200 silicon-bonded hydrogen atoms per molecule, and most preferably 4-50 silicon-bonded hydrogen atoms per molecule. The organohydrogensiloxane preferably has a viscosity of up to about 10,000 mPas at 25° C., preferably up to 1,000 mPas at 25° C. The silicon-bonded organic groups present in the organohydrogensiloxane can include substituted and unsubstituted alkyl groups of 1-4 carbon atoms that are otherwise free of ethylenic or acetylenic unsaturation. Preferably each organohydrogensiloxane molecule comprises at least three silicon-bonded hydrogen atoms in an amount which is sufficient to give a molar ratio of Si—H groups in the organohydrogensiloxane to the total amount of alkenyl or alkynyl groups in polymer of from 1:1 to 10:1.

Any suitable hydrosilylation catalyst may be utilised. Such hydrosilylation catalysts are known in the art and include any metal-containing catalyst which facilitates the reaction of silicon-bonded hydrogen atoms with the unsaturated hydrocarbon group, typically ruthenium, rhodium, palladium, osmium, iridium or platinum. Suitable hydrosilylation catalysts include chloroplatinic acid, alcohol-modified chloroplatinic acids, olefin complexes of chloroplatinic acid, complexes of chloroplatinic acid and divinyltetramethyldisiloxane, fine platinum particles adsorbed on carbon carriers, platinum supported on metal oxide carriers such as Pt(Al₂O₃), platinum black, platinum acetylacetonate, platinum(divinyltetramethyldisiloxane), platinous halides exemplified by PtCl₂, PtCl₄, Pt(CN)₂, complexes of platinous halides with unsaturated compounds exemplified by ethylene, propylene, and organovinylsiloxanes, styrene hexamethyldiplatinum. Such noble metal catalysts are described in U.S. Pat. No. 3,923,705 to show platinum catalysts. One preferred platinum catalyst is Karstedt's catalyst, a platinum divinyl tetramethyl disiloxane complex typically containing one weight percent of platinum in a solvent such as toluene which is described in U.S. Pat. No. 3,715,334 and U.S. Pat. No. 3,814,730. Another preferred platinum catalyst is a reaction product of chloroplatinic acid and an organosilicon compound containing terminal aliphatic unsaturation, see U.S. Pat. No. 3,419,593. Most preferred as the catalyst is a neutralised complex of platinous chloride and divinyl tetramethyl disiloxane, see U.S. Pat. No. 5,175,325.

Ruthenium catalysts such as RhCl₃(Bu₂S)₃ and ruthenium carbonyl compounds such as ruthenium 1,1,1-trifluoroacetylacetonate, ruthenium acetylacetonate and triruthenium dodecacarbonyl or a ruthenium 1,3-ketoenolate may alternatively be used. Other hydrosilylation catalysts suitable for use in the present invention include for example rhodium catalysts and suitable iridium catalysts.

The catalyst may be added to the present composition in an amount equivalent to as little as 0.001 part by weight of the metal per one million parts (ppm) of the composition. Preferably, the concentration of metal in the composition is that capable of providing the equivalent of at least 1 part per million of elemental metal. A catalyst concentration providing the equivalent of about 3-50 parts per million of elemental metal is generally the amount preferred.

Any suitable filler or combination of fillers may optionally be utilised. The compositions may contain one or more finely divided, reinforcing fillers, such as fumed or precipitated silica, and/or calcium carbonate, and/or non-reinforcing fillers, such as crushed quartz, diatomaceous earths, barium sulfate, iron oxide, titanium dioxide, carbon black, talc, and wollastonite. Other fillers which might be used alone or in addition to the above include aluminite, calcium sulfate (anhydrite), gypsum, calcium sulfate, magnesium carbonate, zinc oxide, clays, e.g. kaolin, aluminium trihydroxide, magnesium hydroxide (brucite), graphite, copper carbonate, e.g. malachite, nickel carbonate, e.g. zarachite, barium carbonate, e.g. witherite and/or strontium carbonate e.g. strontianite, aluminium oxide, silicates selected from olivine group, garnet group, aluminosilicates, ring silicates, chain silicates and sheet silicates (the olivine group comprises silicate minerals, such as but not limited to, forsterite and Mg₂SiO₄; the garnet group comprises ground silicate minerals, such as but not limited to, pyrope, Mg₃Al₂Si₃O₁₂, grossular, and Ca₂Al₂Si₃O₁₂; aluninosilicates comprise ground silicate minerals, such as but not limited to, sillimanite, Al₂SiO₅, mullite, 3Al₂O₃.2SiO₂, kyanite, and Al₂SiO₅, the ring silicates group comprises silicate minerals, such as but not limited to, cordierite and Al₃(Mg,Fe)₂[Si₄AlO₁₈]; the chain silicates group comprises ground silicate minerals, such as but not limited to, wollastonite and Ca[SiO₃]; the sheet silicates group comprises silicate minerals, such as but not limited to, mica, K₂Al₁₄[Si₆Al₂O₂₀](OH)₄, pyrophyllite, Al₄[Si₈O₂₀](OH)₄, talc, Mg₆[Si₈O₂₀](OH)₄, serpentine for example, asbestos, Kaolinite, Al₄[Si₄O₁₀](OH)₈, and vermiculite). Yet another type of filler could be a low density filler, such as glass microspheres or polymer beads which may be used to lighten the weight of the composition according to the invention.

Alternatively, the filler may comprise an organopolysiloxane resin. The organopolysiloxane resin may be exemplified by resins comprising: the (CH₃)₃SiO_{1/2} unit and SiO_{4/2} unit; the (CH₃)₃SiO_{1/2} unit, (CH₂═CH)SiO_{3/2} unit, and SiO_{4/2} unit; the (CH₂═CH)(CH₃)₂SiO_{1/2} unit and SiO₄₁₂ unit; and the (CH₂═CH)(CH₃)₂SiO_{1/2} unit (CH₂═CH)SiO_{3/2} unit, and SiO_{4/2} unit. Among these resins, the vinyl-containing resins are preferred because they lead to an improvement in the strength of the silicone rubber coating membrane.

In addition, a surface treatment of the filler(s) may be performed, for example with a fatty acid or a fatty acid ester such as a stearate, or with organosilanes, organosiloxanes, or organosilazanes hexaalkyl disilazane or short chain siloxane diols to render the filler(s) hydrophobic and therefore easier to handle and obtain a homogeneous mixture with the other components The surface treatment of the fillers makes them easily wetted by the silicone polymer. These surface-modified fillers do not clump, and can be homogeneously incorporated into the silicone polymer. Furthermore, the surface-treated fillers give a lower conductivity than untreated or raw material.

Silanes found to be most suitable for the treatment of the filler are alkoxysilanes of the general formula R³(₄₋ₙ)Si(OR³)ₙ, wherein n has a value of 1-3; and each R³ is the same or different and represents a monovalent organic radical such as an alkyl group, an aryl group, or a functional group such as an alkenyl group, e.g. vinyl or allyl, an amino group or an amido group. Some suitable silanes therefore include alkyltrialkoxysilanes such as methyltriethoxysilane, methyltrimethoxysilane, phenyl tialkoxysilanes such as phenyltrimethoxysilane, or alkenyltrialkoxysilanes such as vinyltriethoxysilane, and vinyltrimethoxysilane. If desired, silazanes can also be used as treating agents. These include, but are not restricted to, hexamethyldisilazane, 1,1,3,3-tetramethyldisilazane and 1,3-divinyltetramethyldisilazane. Short chain organopolysiloxanes might for example include hydroxy terminated polydimethylsiloxanes having a degree of polymerisation of from 2 to 20, hydroxy terminated polydialkyl alkylalkenylsiloxanes having a degree of polymerisation of from 2 to 20.

Preferably when treated approximately 1 to 10% by weight of the treated filler will be treating agent. Most preferably the treating agent will be from 2.5 to 10% weight of the treated filler. The filler may be pre-treated before addition to the composition or may be treated in situ during mixing with the polymer.

The proportion of such fillers when employed will depend on the properties desired in the elastomer-forming composition and the cured elastomer. Usually the filler content of the composition will reside within the range 5-500 parts by weight per 100 parts by weight of the polymer excluding the extender portion, preferably 20 to 200 parts, more preferably 50 to 100 parts.

In another embodiment, component A is based on the cross-linking of a polyorganosiloxane preferably having one or more alkenyl or alkynyl functional groups in the presence of an organic peroxide. As previously indicated this is not a preferred route as the use of this free radical initiated cure system is potentially likely to lead to cure of component B in with component A however, if used polyorganosiloxane having alkenyl or alkynyl functional groups is as described hereinabove is preferred. The curing agent is an organic peroxide, such as dialkyl peroxide, diphenyl peroxide, benzoyl peroxide, 1,4-dichlorobenzoyl peroxide, paramethyl benzoyl peroxide, 2,4-dichlorobenzoyl peroxide, di-t-butyl peroxide, dicumyl peroxide, tertiary butyl-perbenzoate, monochlorobenzoyl peroxide, ditertiary-butyl peroxide, 2,5-bis-(tertiarybutyl-peroxy)-2,5-dimethylhexane, 1,1-bis(t-butylperoxy)-3,3,5-trimethylcyclohexane tertiary-butyl-trimethyl peroxide, tertiary-butyl-tertiary-butyl-tertiary-triphenyl peroxide, and t-butyl perbenzoate. The most suitable peroxide based curing agents are benzoyl peroxide, 2,4-dichlorobenzoyl peroxide, di-t-butyl peroxide, and dicumyl peroxide. Organic peroxides such as the above are particularly utilised when R¹ inthe polymer as defined hereinabove is an alkyl group but the presence of some unsaturated hydrocarbon groups per molecule is preferred. Clearly, in this embodiment, the polyorganohydrogensiloxane and hydrosilylation catalyst are not required, although the filler is still preferably used to achieve the necessary 100% modulus.

In a further embodiment, the elastomer may be obtained by cross-linking α,ω-dihydroxypolydiorganosiloxane or a polydiorganosiloxane with two or more hydrolysable groups with a suitable hydrolysable crosslinker having at least 3 hydrolysable groups such as for example an organosilane. The polymer backbone is essentially the same as that described hereinabove, but with optional hydrolysable groups rather than reactive unsaturated groups. However, the polymer end groups are different.

Examples of hydroxyl-terminating or hydrolysable groups include —Si(OH)₃, —(R^{a})Si(OH)₂, —(R^{a})₂SiOH, —R^{a}Si(OR^{b})₂, —Si(OR^{b})₃, —R^{a}₂SiOR^{b} or —SiR^{d}ₚ(OR^{b})₃₋ₚ where each R^{a} independently represents a monovalent hydrocarbyl group, for example, an alkyl group, in particular having from 1 to 8 carbon atoms, (and is preferably methyl); each R^{b} and R^{d} group is independently an alkyl or alkoxy group in which the alkyl groups suitably have up to 6 carbon atoms.

Any suitable hydrolysable cross-linker may be used with the above. The cross-linker may be a silane compound containing at least 3 hydrolysable groups. These include one or more silanes or siloxanes which contain silicon-bonded hydrolysable groups such as acyloxy groups (for example, acetoxy, octanoyloxy, and benzoyloxy groups); ketoximino groups (for example dimethyl ketoximo, and isobutylketoximino); alkoxy groups (for example methoxy, ethoxy, and propoxy) and alkenyloxy groups (for example isopropenyloxy and 1-ethyl-2-methylvinyloxy).

In the case of siloxane based cross-linkers the molecular structure can be straight-chained, branched or cyclic.

Some of the cross-linker may have two condensable groups but the majority preferably have three or four silicon-bonded condensable (preferably hydroxyl and/or hydrolysable) groups per molecule which are reactive with the condensable groups in the organopolysiloxane polymer. When the cross-linker is a silane and when the silane has three silicon-bonded hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. Preferably however, the fourth silicon-bonded organic groups is methyl.

Silanes and siloxanes which can be used as cross-linkers include alkyltrialkoxysilanes such as methyltrimethoxysilane (MTM) and methyltriethoxysilane, alkenyltrialkoxy silanes such as vinyltrimethoxysilane and vinyltriethoxysilane, isobutyltrimethoxysilane (iBTM). Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-methylethylketoximo)silane, methyltris(methylethylketoximino)silane, methyltris(isopropenoxy)silane, vinyltris(isopropenoxy)silane, ethylpolysilicate, n-propylorthosilicate, ethylorthosilicate, dimethyltetraacetoxydisiloxane.

The cross-linker used may also comprise any combination of two or more of the above.

The amount of cross-linker present in the composition of this further embodiment will depend upon the particular nature of the cross-linker and in particular, the molecular weight of the molecule selected. The compositions suitably contain cross-linker in at least a stoichiometric amount as compared to the polymeric material described above. Compositions may contain, for example, from 2-30% w/w of cross-linker, but generally from 2 to 10% w/w. Acetoxy cross-linkers may typically be present in amounts of from 3 to 8% w/w preferably 4 to 6% w/w whilst oximino cross-linkers, which have generally higher molecular weights will typically comprise from 3-8% w/w.

The composition of this further embodiment further comprises a condensation catalyst. This increases the speed at which the composition cures. The catalyst chosen for inclusion in a particular silicone composition depends upon the speed of cure required. Any suitable condensation catalyst may be utilised to cure the composition including tin, lead, antimony, iron, cadmium, barium, manganese, zinc, chromium, cobalt, nickel, titanium, aluminium, gallium or germanium and zirconium based catalysts such as organic tin metal catalysts and 2-ethylhexoates of iron, cobalt, manganese, lead and zinc may alternatively be used. Organotin, titanate and/or zirconate based catalysts are preferred. Silicone compositions which contain oximosilanes or acetoxysilanes generally use an organotin catalysts such as for example dibutyltin dilaurate, dibutyltin diacetate, stannous octoate and chelated tin catalysts such as di(n-butyl)tin bis(ethylacetoacetate) and di(n-butyl) tin bis(acetylacetonate). It is to be noted that these latter catalysts may alternatively be used as co-catalysts in combination with titanate and/or zirconate catalysts such as those discussed below. For compositions which include alkoxysilane cross-linker compounds, the preferred curing catalysts are titanate or zirconate compounds including chelated titanates and zirconates.

Titanate compounds are particularly preferred. Such titanates may comprise a compound according to the general formula Ti[OR]₄ where each R may be the same or different and represents a monovalent, primary, secondary or tertiary aliphatic hydrocarbon group which may be linear or branched containing from 1 to 10 carbon atoms. Optionally the titanate may contain partially unsaturated groups. However, preferred examples of R include but are not restricted to methyl, ethyl, propyl, isopropyl, butyl, tertiary butyl and a branched secondary alkyl group such as 2,4-dimethyl-3-pentyl. Preferably, when each R is the same, R is an unbranched secondary alkyl groups, branched secondary alkyl group or a tertiary alkyl group, in particular, tertiary butyl such as tetrabutyltitanate, tetraisopropyltitanate.

For the avoidance of doubt an unbranched secondary alkyl group is intended to mean a linear organic chain which does not have a subordinate chain containing one or more carbon atoms, i.e. an isopropyl group, whilst a branched secondary alkyl group has a subordinate chain of one or more carbon atoms such as 2,4-dimethyl-3-pentyl.

Any suitable chelated titanates or zirconates may be utilised. Preferably the chelate group used is a monoketoester such as acetylacetonate and alkylacetoacetonate giving chelated titanates such as, for example diisopropyl bis(acetylacetonyl)titanate, diisopropyl bis(ethylacetoacetonyl)titanate, diisopropoxytitanium bis(ethylacetoacetate) and the like.

Examples of suitable catalysts are additionally described in EP1254192 and WO 2001/49774.

Preferably the condensation catalyst, will be present in an amount of from 0.3 to 6 parts by weight per 100 parts by weight of polymer, i.e. from about 0.2 to 2 weight % of the composition. The catalyst may be present in an amount of greater than 6 parts by weight in cases where chelating agents are used.

Certain additional components may optionally be included in the elastomer-forming composition to be used in the present invention. To obtain a longer working time or “pot life”, the activity of hydrosilylation catalysts under ambient conditions can be retarded or suppressed by addition of a suitable inhibitor. Known platinum-group metal catalyst inhibitors include the acetylenic compounds disclosed in U.S. Pat. No. 3,445,420. Acetylenic alcohols such as 2-methyl-3-butyn-2-ol and 1-ethynyl-2-cyclohexanol constitute a preferred class of inhibitors that suppress the activity of a platinum-based catalyst at 25° C. Compositions containing these catalysts typically require heating at temperatures of 70° C. or above to cure at a practical rate. Room temperature cure is typically accomplished with such systems by use of a two-part system in which the cross-linker and inhibitor are in one of the two parts and the platinum is in the other part. The amount of platinum is increased to allow for curing at room temperature.

Inhibitor concentrations as low as one mole of inhibitor per mole of platinum-group metal will, in some instances, impart satisfactory storage stability and cure rate. In other instances inhibitor concentrations of 500 or more moles of inhibitor per mole of platinum-group metal are required. The optimum concentration for a given inhibitor in a given composition can readily be determined by routine experimentation.

Additional components can be added to the hydrosilylation composition which are known to enhance such reactions. These components include salts such as sodium acetate which have a buffering effect in combination with platinum-type catalysts.

Other ingredients which may be included in the compositions include but are not restricted to co-catalysts for accelerating the cure of the composition such as metal salts of carboxylic acids and amines, rheological modifiers, adhesion promoters, pigments, colouring agents, desiccants, heat stabilizers, flame retardants, UV stabilisers, chain extenders, cure modifiers, electrically and/or heat-conductive fillers, blowing agents, foaming agents, anti-adhesive agents, handling agents, peroxide cure co-agents, acid acceptors, fungicides and/or biocides and the like (which may suitably by present in an amount of from 0 to 0.3% by weight), water scavengers, (typically the same compounds as those used as cross-linkers or silazanes). It will be appreciated that some of the additives are included in more than one list of additives. Such additives would then have the ability to function in each manner as stated.

The rheological additives include silicone organic co-polymers such as those described in EP 0 802 233 based on polyols of polyethers or polyesters, non-ionic surfactants selected from the group consisting of polyethylene glycol, polypropylene glycol, ethoxylated castor oil, oleic acid ethoxylate, alkylphenol ethoxylates, copolymers or ethylene oxide (EO) and propylene oxide (PO), and silicone polyether copolymers; as well as silicone glycols.

Adhesion promoter(s) may also be incorporated. These may include alkoxysilanes such as aminoalkylalkoxy silanes, epoxyalkylalkoxy silanes, for example, 3-glycidoxypropyltrimethoxysilane and mercapto-alkylalkoxy silanes and γ-aminopropyl triethoxysilane, reaction products of ethylenediamine with silylacrylates. Isocyanurates containing silicon groups such as 1,3,5-tris(trialkoxysilylalkyl) isocyanurates may additionally be used. Further suitable adhesion promoters are chelated materials or reaction products of epoxyalkylalkoxy silanes such as 3-glycidoxypropyltrimethoxysilane with amino-substituted alkoxysilanes such as 3-aminopropyltrimethoxysilane and optionally alkylalkoxy silanes such as methyl-trimethoxysilane, epoxyalkylalkoxy silane, mercaptoalkylalkoxy silane, and derivatives thereof.

Heat stabilizers may include iron oxides and carbon blacks, iron carboxylate salts, cerium hydrate, barium zirconate, zinc oxide, magnesium oxide, cerium and zirconium octoates, and porphyrins.

Flame retardants may include for example, carbon black, hydrated aluminium hydroxide, and silicates such as wollastonite, platinum and platinum compounds.

Electrically conductive fillers may include carbon black, metal particles such as silver particles any suitable, electrically conductive metal oxide fillers such as titanium oxide powder whose surface has been treated with tin and/or antimony, potassium titanate powder whose surface has been treated with tin and/or antimony, tin oxide whose surface has been treated with antimony, and zinc oxide whose surface has been treated with aluminium.

Thermally conductive fillers may include metal particles such as powders, flakes and colloidal silver, copper, nickel, platinum, gold aluminium and titanium, metal oxides, particularly aluminium oxide (Al₂O₃) and beryllium oxide (BeO), magnesium oxide, zinc oxide, zirconium oxide, ceramic fillers such as tungsten monocarbide, silicon carbide and aluminium nitride, boron nitride and diamond.

Handling agents are used to modify the uncured properties of the silicone rubber such as green strength or processability sold under a variety of trade names such as SILASTIC®HA-1, HA-2 and HA-3 sold by Dow Corning Corporation).

Peroxide cure co-agents are used to modify the properties, such as tensile strength, elongation, hardness, compression set, rebound, adhesion and dynamic flex, of the cured rubber. These may include di- or tri-functional acrylates such as trimethylolpropane triacrylate and ethylene glycol dimethacrylate; triallyl isocyanurate, triallyl cyanurate, polybutadiene oligomers and the like. Silyl-hydride functional siloxanes may also be used as co-agents to modify the peroxide catalysed cure of siloxane rubbers.

The acid acceptors may include magnesium oxide, calcium carbonate, zinc oxide and the like.

The ceramifying agents can also be called ash stabilisers and include silicates such as wollastonite.

Plasticisers or extenders may be utilised, if required. Examples include those reviewed in GB 2 424 898, and those described in WO 2008/045417 but in view of component B typically no organic type plasticiser and/or extender (sometimes referred to as a processing aid) will be additionally required.

Optional diluents to be used with HCRs (and possibly with LSRs of higher viscosities) include aliphatics, namely white spirit, Stoddard solvent, hexane, heptane, c-hexane, and aromatics such as toluene and xylene.

Component B is a substantially non-reactive silicone fluid. Preferably Component B is totally non-reactive, although small amounts of reactivity can be tolerated in most instances. By non-reactive is meant that it does not react chemically (to form a covalent bond) with the pre-cursors of component A. The non-reactive silicone fluid may be a polyorganosiloxane described by the following formula:

R₃SiO[(R₂SiO)ₙ]SiR₃

wherein each R is the same or different and represents C₁₋₁₈ alkyl (preferably C₁₋₈ alkyl and more preferably C₁₋₄ alkyl) or aryl (e.g. phenyl or naphthyl), either of which may optionally be further substituted with non-reactive groups, such as fluoro (e.g. a trifluoroalkyl group); preferably each R group is a methyl or ethyl group. It is typically a trialkyl silyl terminated polydimethylsiloxane (PDMS) fluid. Most preferably each terminal alkyl group is either methyl or ethyl but are not necessarily the same.

Alternatively, or in addition, the non-reactive silicone fluid may contain a polyorganosiloxane having a degree of branching due to the presence of one or more of either or both of the following groups in the R₃SiO[(R₂SiO)ₙ]SiR₃ polymer backbone:

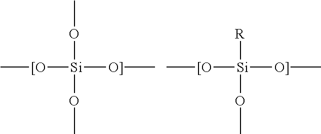

wherein R is as described hereinabove, and each R group may be the same or different.

The value of n is such that the polymer has the required viscosity. The viscosity of component B is 1,000-3,000,000 mPas, preferably 3,000-3,000,000 mPas, more preferably 10,000-1000,000 mPas, at 25° C. It should be noted that 1 mPas is 0.1 Poise. A Poise is a cgs unit of viscosity equal to the tangential force in dynes per cm² required to maintain a difference in velocity of 1 cms⁻¹ between two parallel planes of a fluid separated by 1 cm. This is measured using a rotational flow method, which uses a rotating spindle immersed in the test liquid and measures torque and hence resistance to flow of the liquid. Measurements may be taken using a Brookfield rotational viscometer (for example model DV III) having a CP52 spindle, operating at 0.5 rpm and measured at 25° C. Component B, in isolation, is shear thinning, meaning that the viscosity decreases with increasing shear rate or Newtonian.

Other silicone fluids may also be used provided that they meet the viscosity requirements. In order to increase the compatibility with the elastomer component A, especially where such elastomer is a non-silicone elastomer, for example a polyurethane elastomer, copolymers may be used where organic groups which improve the compatibility may be included. Such materials include for example silicone urethane copolymers, silicone-urea copolymers, silicone polyether copolymers, silicone amine copolymers and others. These copolymer materials are also preferably shear thinning.

The composition of the present invention is obtained by forming an intimate mixture of components A and B. In one embodiment, the composition consists essentially of components A and B. By essentially, is meant that conventional additives such as those described hereinabove, but which do not adversely affect the energy-absorption properties, may be included. The composition preferably contains 5-80% by weight of component B, based on the totally weight of the composition, and preferably 20-60% by weight, and most preferably 30-50%. The resulting composition exhibits viscoelastic properties. As used herein, the term viscoelastic refers to the property of exhibiting shear-rate dependent strain, having both liquid (linear strain when stressed) and elastic (instantaneous strain when stressed) properties. For the avoidance of doubt, this is a different property to dilatancy which means that under impact conditions, the strain rate is very high and the composition exhibits elastic properties, whereas under normal conditions when strained slowly, the composition exhibits substantially viscous properties.

Alternative ways of improving the compatibility of components A and B or of the precursors of component A with component B, in order to ensure the intimate mixture could include the use of emulsions, solvents or other dispersing aids.

The composition described in the use of the present invention is preferably prepared by forming component (A) in the presence of component (B) and is thus formed by intimately mixing the curable elastomer-forming composition which may cure into component A together with component B. It therefore preferably comprises the steps of (a) mixing (i) a curable polymer, e.g. a polyurethane precursor or an polyorganosiloxane, (ii) potentially a filler, (iii) a curing package, e.g. isocyanate or a silicone based crosslinker and where necessary a catalyst and (B) a non-reactive silicone fluid, having a viscosity of 1,000-3,000,000 mPas at 25° C.; and (b) curing the resultant mixture. Typically all the ingredients are individually pre-prepared and introduced individually into the mixture. The components (i)-(iii) and (B) are as described hereinabove. Preferably curing is performed by heating the resultant mixture. It is possible to perform the curing in stages and it can be envisaged to mix part of components A and B, followed by some curing, followed by further mixing and curing of remaining parts of the relevant components.

Thus, component A is formed by reacting or cross-linking its component parts in the presence of component B allowing component B to be dispersed throughout the matrix formed by component A. However, component B is substantially unreactive and hence does not become covalently bonded to component A to any large extent. By unreactive (or non-reactive) is meant that component B does not react with the precursors of component A during the cross-linking (curing) process and hence does not participate in the cross-linking (or chain extension) reaction. Clearly, the chemical nature of component B will depend on the nature of the curing reaction. For example, a vinyl-substituted polyorganosilane would be considered reactive if component A is prepared by cross-linking using the hydrosilylation reaction or siloxanes, but would not be reactive if component A is prepared by a condensation reaction or siloxanes. This forms an intimate mixture of the two components, i.e. a mixture in which component B is dispersed throughout component A. It is a mixture as the two components are not chemically bonded (covalently bonded) to one another. Although not wishing to be bound by theory, it is believed that the intimate mixture of these two components, together with the high viscosity of component B, allows component B to resist flow under impact.

The composition may be formed into an impact-resistant material. The impact-resistant material may be formed solely of the composition of the present invention, particularly where the composition is self-supporting. For example, the impact-resistant material may be composed of a foam based on a matrix formed from the composition of the present invention. The composition is treated with a foaming agent during the curing process so that sheet material is in the form of a foam composed solely of the elastomeric material, which could be for example a polyurethane or a silicone composition, having component B distributed throughout the elastomeric foam. The impact-resistant material may also comprise the composition of the present invention together with a reinforcing material, such as reinforcing fibres, e.g. polyester, polyamide, polyaramide, polyolefin, polyimide, polyacrylonitrile, PTFE, cotton, carbon fibres, glass fibre and/or silica fibres.

Alternatively, the impact-resistant material may be formed of a substrate together with the elastomer composition of the present invention. The substrate supports the composition and provides structural integrity (indeed, the substrate would typically have structural integrity in the absence of the composition). The substrate may be impregnated and/or coated with the elastomer composition. Where the substrate is impregnated, the substrate has voids/cavities into which the composition may enter. Although any amount of the composition will improve the performance of a substrate compared to the untreated substrate, preferably the composition is present at 100-5,000 g/m², more preferably 500-3,000 g/m².

The substrate may be a fabric, such as a woven fabric (e.g. a fleece material), a non-woven fabric or a knitted fabric (often in the form of and/or sold as a spacer textile, typically a 3 dimensional spacer textile). The fabric may be formed of any suitable material, such as, for example, polyester, polyamide, polyolefin, aromatic polyamide, cotton, wool, acrylic or cellulosic fibres. It may be constructed with an abrasion resistant fibre such as aromatic polyamide arranged to be at the outer surface of a protective garment with a comfort fibre, such as cotton or a wicking microfiber, at the inner surface.

The substrate may be impregnated with the composition of the present invention. The composition may need to be diluted with an organic solvent to the optimum viscosity for application to the substrate. Examples of suitable solvents are aliphatics, namely white spirit, Stoddard solvent, hexane, heptane, c-hexane, and aromatics such as toluene and xylene. The solvent can be a supercritical fluid, for example supercritical carbon dioxide. The concentration of composition in such a solution may, for example, be 10-95% by weight, usually from 20-80% by weight. The composition may also be introduced into or onto the substrate by providing the composition in emulsion form.

After impregnation the sheet material is dried, either by allowing the fabric to dry under ambient conditions or by applying heat and/or a current of a drying gas such as air to accelerate drying. Drying can for example be carried out at 40-200° C., particularly 80-180° C.

The substrate may also be a foam, such as an open cell, partially open cell, or closed cell foam, e.g. a polyurethane foam or cellulose foam or foam materials made from individual foamed beads linked together by melt bonding or chemical binder materials.

A foam impregnated with a composition can be produced by mixing the composition with foam-forming ingredients which are then allowed to foam. The foam-forming ingredients may be a plastics material mixed with a latent-gas-generating material but are preferably reagents which react to form a foam blown with gas generated during the reaction, for example polyurethane foam precursors such as an isocyanate or blocked isocyanate and an active hydrogen compound such as a polyol, particularly a polyether polyol and/or a polyester polyol.

The composition of the present invention may be mixed with the foam-forming ingredients prior to or after forming and curing the foam.

According to one aspect of the invention, the substrate is an auxetic material, that is a material having a negative or effectively negative Poisson ratio so that it expands perpendicular to an axis about which it is stretched. Auxetic materials are described, for example, in WO 2004/088015, WO 00/53830, U.S. Pat. No. 4,668,557 and WO 91/01210. The impact protection can be enhanced by using an auxetic material as the substrate.

The impact-resistant material of the present invention may include a substrate which is a resilient carrier with voids or cavities therein, as described in WO 03/022085, but employing the composition of the present invention rather than the dilatant material described therein. The resilient carrier is coated, impregnated or combined with the composition of the present invention such that the resilient carrier supports the composition.

The following preferred embodiments for the resilient carrier described in WO 03/022085 apply equally to the substrate of the present invention. Thus, the substrate may be a spacer material; the spacer material may comprise a resilient core sandwiched between a pair of covering layers. This may take the form of a ribbed material sandwiched between a top sheet and a bottom sheet (see FIGS. 1 and 2 and the accompanying text of WO 03/022085) or resilient partitions which are sandwiched between and joined to a top sheet and a bottom sheet (see FIGS. 5 and 6 and the accompanying text). Of course, it is also possible to provide only one sheet on which the elastomer material is provided. An alterative is a “hex-type” spacer material (see FIG. 7 and the accompanying text of WO 03/022085). The outer surface of each covering layer may be formed with a plurality of compressible bubbles therein (see FIG. 8 and the accompanying text of WO 03/022085), and elongate hollow channels may be formed in the compressible core. In addition, upper and lower textile layers may be formed with a plurality of pockets formed therein by stitching, with the pockets filled with the composition of the present invention, e.g. impregnated in the fibres (see FIG. 9 and the accompanying text). One advantage of using such materials is their breathability when composition described in the present invention is applied to the substrate but does not fill the hollow channels or apertures therein.

The substrate based on that disclosed in WO 03/022085 may also have holes formed there through. The substrate may also be a foam (see FIGS. 3 and 4 and the accompanying text). Alternatively, the impact-resistant material may be formed of discrete modules made of composition of the present invention sandwiched between a pair of covering layers (see FIGS. 10-13 and the accompanying text). The modules may be randomly arranged in the compressible core, arranged in axially aligned rows across the width of the sheet or as parallel elongate hollow tubular members. Also, each module may have a covering layer thereon. The modules may be spherical and they may be hollow or have a lightweight centre. The impact-resistant material may also be formed into a shaped article, e.g. a knee or elbow pad, or a shoe (see FIGS. 21-23 and 25 and the accompanying text).

The impact-resistant material of the present invention may alternatively include a substrate as disclosed in WO 03/055339. This embodiment of the present invention, based on WO 03/055339, provides a self-supporting energy absorbing composite comprising a solid foamed synthetic polymer matrix and the composition of the present invention. The matrix is preferably elastic, more preferably a synthetic elastomer, and most preferably an elastomeric polyurethane.

In a preferred embodiment, the self-supporting energy absorbing composite is a foam and the composition of the present invention is contained in the pores of the foam.

The foam may be an open-cell, closed-cell or part-open-part-closed foam. The foam recovers after being subjected to compression and recovery is preferably complete after 5 seconds or less and more preferably 2 seconds or less. The composition of the present invention is preferably included during the formation of the foam.

An example of the base polyurethane system is that available as J-Foam 7087 from Jacobson Chemicals Ltd in Farnham, Surrey. Further details are given in Examples 1 and 2 of WO 03/055339.

Alternatively, rather than being a substrate for the composition of the present invention, the composition of the present invention may be formed into an impact-resistant material without a substrate, as described hereinabove, but in the form of the material described in WO 03/055339. That is, component A of the present invention may be the solid foamed synthetic polymer matrix of WO 03/055339 and component B of the present invention may take the place of the dilatant of WO 03/055339. However, the composition of the present invention (by using an elastomer of the specified modulus, and a fluid with the specified viscosity range) provides improved impact resistance.

WO 03/055339 also provides a cross-reference to JP 06-220242. JP 06-220242 discloses an impact cushioning material obtained by coating the surface of a skeletal lattice of a flexible three-dimensional network or foam having continuous internal voids with a silicone bouncing putty. The impact-resistant material of the present invention may also be based on this skeletal lattice as the substrate. This lattice may be exemplified by plastic foams that have an open cell structure, for example, polyethylene, polystyrene, polyvinyl chloride, polyurethane, phenolic resin, urea resin, methacrylic resin, or silicone resin; by porous natural materials, e.g. sponge and cork; or by porous materials composed of a fibrous substance, e.g. woven fabrics and nonwoven fabrics.

The impact-resistant material of the present invention is preferably in the form of a sheet, e.g. with a thickness of 1-30 mm. The sheet may have a uniform thickness or the thickness may vary within the range of 1-30 mm. The sheet may also be composed of a plurality of layers which together form the sheet having the desired thickness.

The composition described in the present invention may be applied by any suitable method of application. Examples include but are not restricted to spray coating, curtain coating, die coating, dip coating, knife coating and screen coating.

The impact-resistant material may also be in the form of a shaped article, for example so that it conforms to the contours of the human or animal body, e.g. knee, elbow or shoulder protection. Examples e.g. for preventing/protecting the wearer from blunt trauma include (in each case as a separate protector or formed into a garment or included as part of a garment, elbow protectors, knee protectors, forearm protectors, thigh protectors, chest protectors, back protectors, shoulder, lower leg protectors and chest protectors shinguards, shin protectors, helmets, head protectors, hip protectors, gloves, kidney protection and coccyx protection. The impact-resistant material may also be in the form of footwear—e.g. heel of the shoe, forefoot, shoe upper or may be in protective sports equipment—e.g. rugby post protectors, training equipment, landing mats, cricket pads and gloves etc.

The protective equipment incorporating the impact-resistant material described in the present invention may be for contact sports, high risk sports and activities or the like such as but not restricted to rugby, soccer, American football, baseball, basketball, martial arts, boxing, sailing, windsurfing, wakeboarding, ice-skating, speedskating, snowboarding, skiing, ice-hockey, field hockey, roller hockey, roller blading, cricket, hurling, lacrosse, mountain biking, cycling, bobsleigh, extreme sports e.g. bungee jumping and weightlifting, motorcycling.

The impact-resistant material may also be used in medical applications e.g. for hip protection, head protection for vulnerable people, protective devises to aid recovery from injury and/or orthopaedic devices or in work protection wear e.g. safety gloves, safety footwear, safety clothing.

Another application for the impact-resistant material is in the protection of items or articles into which the impact-resistant material may be incorporated or which may use the impact-resistant material as an encasement, e.g. suitcases, laptop cases, laptop backpacks, camera cases, mobile phone cases, portable music equipment cases, golf clubs, surfboard protection, radio and in packaging for fragile items in transportation, lining of vehicles and crates for transportation. Furthermore, the impact-resistant material may be used in transportation applications such as automobile dashboards, bumpers, and safety equipment in other transport e.g. trains and aeroplanes

In use a plurality of layers of the treated impact protection material may be utilised in order to suit the application for which it is to be used. The layers may be identical or may be a combination of alternative substrates described above or alternatively may be a combination of one or more layers of impact protection material according to the present invention and layers of other materials. Furthermore, the composition described in the present invention may be applied alone to a substrate or may be applied with other suitable materials which do not negatively affect the impact resistance of the treated materials. Examples might include gels, resins and foams or the like.

The present invention will now be described with reference to the following examples, which are not intended to be limiting.

### EXAMPLES

### Example 1

A composition was prepared using the following components, in which the quantities are given in parts by weight.

### Part (i):

65.4 dimethylvinylsiloxy-terminated dimethyl siloxane having a viscosity at 25° C. of 2,000 mPas
4.2 hexamethyldisilazane
1.4 water
29.0 precipitated silica, Degussa FK320DS
0.1 1,3-diethenyl-1,1,3,3-tetramethyldisiloxane platinum complex

The hexamethyldisilazane, water and a portion of the vinylsiloxane were added to a high shear mixer. FK320DS was added incrementally until it was well dispersed. The resulting mixture was then heated to 170° C. under vacuum. The remaining vinylsiloxane and platinum complex were then added.

### Part (ii):

72.5 dimethylvinylsiloxy-terminated dimethyl siloxane having a viscosity at 25° C. of 2,000 mPas
27.0 trimethylsiloxy-terminated dimethyl, methylhydrogen siloxane having a viscosity at 25° C. of 5 mPas and a hydrogen content bonded to silicon of 0.8% w/w
0.5 ethynyl cyclohexanol

The ingredients were mixed until homogeneous, with mild heating (50° C.) which helped to dissolve the ethynyl cyclohexanol.

Parts (i) and (ii) were then mixed in the ratio 10:1 by weight and the blend was designated silicone elastomer 1 (SE1). This mixture was then blended with a polydimethylsiloxane (PDMS) at the required ratio (see herein below for further details of the PDMS).

### Example 2

A composition was prepared using the following components, in which the quantities are given in parts by weight.

### Part (i)

19.8 vinyl functional methyl polysiloxane resin, comprising the Vi(Me)₂SiO_{1/2} unit and SiO_{4/2} unit with Vi group content 3.25% w/w
52.0 dimethylvinylsiloxy-terminated dimethyl siloxane having a viscosity at 25° C. of 2,000 mPas 15.0 dimethylvinylsiloxy-terminated dimethyl siloxane having a viscosity at 25° C. of 55,000 mPas
0.1 1,3-diethenyl-1,1,3,3-tetramethyldisiloxane platinum complex

All ingredients were blended together in a low shear mixer essentially following the procedure of Example 1.

### Part (ii)

7.8 vinyl functional methyl polysiloxane resin, comprising the Vi(Me)₂SiO_{1/2} unit and SiO_{4/2} unit with Vi group content 3.25% w/w
61.0 trimethylsiloxy-terminated dimethyl, methylhydrogen siloxane having a viscosity at 25° C. of 5 mPas and a hydrogen content bonded to silicon of 0.8% w/w
24.3 dimethylvinylsiloxy-terminated dimethyl siloxane having a viscosity at 25° C. of 2,000 mPas
0.5 ethynyl cyclohexanol

All ingredients were blended together in a low shear mixer essentially following the procedure of Example 1.

Parts (i) and (ii) were then mixed in the ratio 10:1 by weight and the blend was designated silicone elastomer 2 (SE2). This mixture was then blended with PDMS at the required ratio (see below).

### Example 3

A composition was prepared using the following components, in which the quantities are given in parts by weight.

### Part (i)

12.0 dimethylvinylsiloxy-terminated dimethyl siloxane having a viscosity at 25° C. of 55,000 mPas
52.0 dimethylvinylsiloxy-terminated dimethyl siloxane having a viscosity at 25° C. of 2,000 mPas
16.8 vinyl functional methyl polysiloxane resin, comprising the Vi(Me)₂SiO_{1/2} unit and SiO_{4/2} unit with Vi group content 3.25% w/w
0.25 water
0.82 hexamethyldisilazane
4.9 fumed silica, Cabot MS75
0.2 1,3-diethenyl-1,1,3,3-tetramethyldisiloxane platinum complex

A majority of the vinyl polymers, silica, water and treating agents were combined. The mixture was then heated and stripped under vacuum. The remaining polymer was then added.

### Part (ii)

12.0 dimethylvinylsiloxy-terminated dimethyl siloxane having a viscosity at 25° C. of 55,000 mPas
36.7 dimethylvinylsiloxy-terminated dimethyl siloxane having a viscosity at 25° C. of 2,000 mPas
0.25 water
0.82 hexamethyldisilazane
4.9 fumed silica, Cabot MS75
11.8 vinyl functional methyl polysiloxane resin, comprising the Vi(Me)₂SiO_{1/2} unit and SiO_{4/2} unit with Vi group content 3.25% w/w
9.3 trimethylsiloxy-terminated dimethyl, methylhydrogen siloxane having a viscosity at 25° C. of 5 mPas and a hydrogen content bonded to silicon of 0.8% w/w
1.8 trimethylsiloxy terminated dimethyl, methylhydrogen siloxane having a viscosity at 25° C. of 30 mPas and a hydrogen content bonded to silicon of 1.6% w/w
0.1 ethynyl cyclohexanol

A majority of the vinyl polymers, silica, water and treating agents were combined. The mixture was then heated and stripped under vacuum. The remaining polymer was then added.

Parts (i) and (ii) were then mixed in the ratio 10:1 by weight and the blend was designated silicone elastomer 3 (SE3). This mixture was then blended with a PDMS at the required ratio (see below).

### Example 4

The mixtures produced in Examples 1-3 were impregnated at different ratios into various substrates, namely:
a 5 mm thick spacer fabric of 590 g/m²
a 7 mm thick spacer fabric of 570 g/m²
a 8mm non-woven fabric of 500 g/m²

Suppliers of spacer fabrics include: Baltex, UK; CIMA, Spain; Dafa, PRC; Heathcoat, UK; Mueller, Germany; and Scott & Fyffe, UK. Suppliers of non-woven fabrics include Captiqs, Belgium; Danweb, Denmark; Ecotextil, Czech Republic; Freudenberg, Germany; JSC Neaustima, Lithuania; Sandler, Germany; and Ziegler, Germany.

The fabric was then heat treated at 180° C. for 10 minutes to cure the silicone. The handle of the impregnated fabric was soft and flexible with good resilience, but without excessive impacter bounce.

The fabrics were then subjected to impact testing. All impact testing was carried out according to EN1621 Parts 1 and 2 “Motorcyclists' protective clothing against mechanical impact”, where a 5 kg weight of specified shape was caused to impact the device held over an anvil of specified shape, such that the impact energy is 50 J. A load cell within the anvil measures the resultant impact force transmitted through the device. Additional data were also obtained at an impact energy of 30 J.

The results are set out herein below.

### Various Elastomer and Viscoelastic Materials

The various types of elastomer were tested and the results are shown in the following table.

### EN1621-1 Test

Impact force (kN)

| Fabric + silicone | 30 J | 50 J |
|---|---|---|
| 2 × 5 mm spacer fabric | | |
| Silicone elastomer + fluid | 19 | 40 |
| (SE3 + 12,500 mPas PDMS, 50/50) | | |
| 2,167 g/m² (example of the invention) | | |
| 2 × 7 mm spacer fabric | | |
| Silicone elastomer (SE1), 2110 g/m² | 28 | 34 |
| Silicone elastomer (SE3), 2387 g/m² | 23 | 31 |
| Silicone elastomer + fluid | 18 | 29 |
| (SE3 + 12,500 mPas PDMS, 50/50), | | |
| 2214 g/m² (example of the invention) | | |
| 2 × 8 mm Non-woven fabric | | |
| Silicone elastomer + fluid | | 22 |
| (SE2 + 60,000 mPas PDMS, 70/30) | | |
| 2500 g/m² (example of the invention) | | |

Notes:
The silicone elastomers: 1, 2 and 3 were prepared in Examples 1-3, respectively.

A reduced impact force was observed using fabrics impregnated with the viscoelastic silicone elastomer of the present invention.

### Wash Resistance

There is a need for protective materials for use used in sports and other applications to be washable in the normal course of use. This is especially the case if the protection is sewn directly into the garment or is otherwise non-removable. The impact fabrics were washed according to EN 6330 using a machine wool wash programme at 40° C. Twenty washes did not cause any significant change in impact force transmission in the EN 1621-1 tests.

The wash test was as follows. The washing machine used was a domestic machine Hotpoint First Edition 1000, model WM52, using the washing cycle: Wool cycle “J” at 40° C. and 18 L water volume, with “Dreft” (Trade Mark) mild washing powder at 3.38 g/L and a 2 kg fabric load. After each wash, the washed fabric was dried at 80° C. for 2 hours in forced draft oven. The results are shown for various samples impregnated into a 7 mm spacer (two layers of spacer are used for the impact test).

| | EN1621-1 peak force after n washes | | |
|---|---|---|---|
| LSR/fluid type at 50/50 w/w | n = 0 | n = 10 | n = 20 |
| LSR1/fluid1 | 61 | 59 | 61 |
| LSR1/fluid 2 | 70 | 65 | 68 |
| LSR 2/fluid 3 | 30 | 31 | 31 |

LSR1 = SE1
LSR2 = SE3
Fluid 1 = 12,500 mPas PDMS
Fluid 2 = 300,000 mPas PDMS
Fluid 3 = branched 30,000 mPas PDMS

### Impregnation Weight Effect

For any given combination of elastomer and fluid, higher impregnation weight gives lower (better) impact results, particularly at higher impact energy. The results are shown in the following table.

### EN1621-1 Test

| | |
|---|---|
| 2 × 7 mm spacer fabric | Impact force (kN) |

| SE2 + 60,000 mPas PDMS 70/30 | 30 J | 50 J |
|---|---|---|
| 1899 g/m² | 20 | 27 |
| 1795 g/m² | 20 | 37 |
| 1597 g/m² | 22 | 42 |

### Elastomer/Fluid Ration Effect

The impact tests were repeated to investigate the effect of the elastomer:fluid ratio. The results are set out in the following table.

EN1621-1 test

| | Impact force (kN) | |
|---|---|---|
| 2 × 7 mm spacer fabric | 30 J | 50 J |
| SE2 + PDMS 500,000 mPas 70/30 1715 g/m² | 23 | 31 |
| SE2 + PDMS 500,000 mPas 60/40 1696 g/m² | 21 | 33 |
| SE2 elastomer only 1840 g/m² | 25 | 35 |

### EN1621-1 Test

Impact force (kN)

| 2 × 7 mm spacer fabric | 30 J | 50 J |
|---|---|---|
| SE2 + PDMS 60,000 mPas 70/30 1970 g/m² | 21 | 27 |
| SE2 + PDMS 60,000 mPas 60/40 1994 g/m² | 19 | 27 |
| SE2 + PDMS 60,000 mPas 50/50 2127 g/m² | 17 | 31 |

The results show that a higher ratio of elastomer to fluid is more effective at higher energy, but at lower energy, a lower ratio is preferred.

### Fluid Viscosity

The impact tests were repeated to investigate the effect of the fluid viscosity. The results are set out in the following table. Viscosities were measured at 25° C.

### EN1621-1 Test

| | Impact force (kN) | |
|---|---|---|
| 2 × 7 mm spacer fabric | 30 J | 50 J |
| SE2 + PDMS 500,000 mPas 70/30 1715 g/m² | 23 | 31 |
| SE2 + PDMS 60,000 mPas 70/30 1795 g/m² | 20 | 37 |
| SE2 + PDMS 300,000 mPas 50/50 2206 g/m² | 18 | 24 |
| SE2 + PDMS 60,000 mPas 50/50 2112 g/m² | 19 | 28 |
| SE3/SGM* gum 50/50 1933 g/m² | 27 | 35 |
| SE3 + PDMS 500,000 mPas 50/50 1807 g/m² | 21 | 27 |
| SE3 + PDMS 30,000 mPas branched 50/50 1853 g/m² | 24 | 29 |

*SGM = organopolysiloxane gum 700,000 MW (the properties of the gum are such that the viscosity cannot be reliably measured. By way of reference 1M PDMS = 175,000 MW).

The results show that a higher viscosity fluid is more effective at higher energy, but an ultra high molecular weight fluid, i.e. a gum, is not effective. Also, a branched fluid is better than a linear fluid of equivalent viscosity (in this regard, the small difference in the impregnation levels of 1807 and 1853 g/m² are not considered to be significant). The practicality of impregnating a high viscosity mixture may force the use of lower viscosity fluid in some instances.

### Elastomer Properties

The impact tests were repeated to investigate the effect of the elastomer properties. The results are set out in the following table.

### EN1621-1 Test

| | Impact force (kN) | | |
|---|---|---|---|
| | Elastomer | | |
| | 100% modulus | | |
| 2 × 7 mm spacer fabric | ASTM D638-97 | 30 J | 50 J |
| SE2 + PDMS 60,000 | 7.6 | 17 | 31 |
| mPas 50/50 2127 g/m² | | | |
| SE3 + PDMS 60,000 | 5.2 | 20 | 28 |
| mPas 50/50 2112 g/m² | | | |
| 9280 + PDMS 60,000 | 3.1 | 22 | 27 |
| mPas 50/50 2182 g/m² | | | |

Note.
Elastomer 9280 is a commercially available liquid silicone rubber from Dow Corning Limited and sold as Dow Corning ® 9280.

### Elastomer Data

| Product | SE1 | SE3 | SE2 |
|---|---|---|---|
| Durometer | 34 | 54 | 48 |
| Hardness, Shore A | | | |
| (ASTM D2240-97) | | | |
| Modulus 50%, MPa | 0.5 | 1.7 | 7.6 |
| (ASTM D638-97) | | | |
| Tensile strength | 7.8 | 6.9 | 7.5 |
| MPa | | | |
| (ASTM D412-98a) | | | |
| Elongation at break | 472 | 150 | 160 |
| (ASTM D412-98a) | | | |

The results show that at lower energy, i.e. below about 45 J, the impact performance correlation to modulus of the elastomer is good. Above this energy, the performance is more determined by the fluid viscosity and the correlation breaks down.

### Using a Reactive Vinyl Fluid in Place of Unreactive PDMS

The impact tests were repeated to investigate the effect of the reactivity of the fluid with the elastomer. A reactive vinyl-functional PDMS (vinyl end groups) was used in place of a non-reactive PDMS. The vinyl polymer used has a viscosity of 50,000 mPas at 25° C.

The handle of the fabric impregnated with the vinyl fluid is stiffer than the comparable fabric with unreactive fluid. The results of the impact tests are set out in the following table.

### EN1621-1

Impact force (kN)

| 2 × 7 mm spacer fabric | 30 J | 50 J |
|---|---|---|
| SE3/60,000 50/50 2112 g/m² | 19 | 28 |
| SE3/50,000 mPas vinyl 50/50 2242 g/m² | 25 | 30 |

The fabric impregnated with the vinyl fluid was found to have poorer performance. It is believed that the vinyl-functional PDMS reacts with the elastomer during cure and so is bound to the elastomer adversely affecting the flow properties.

### Reinforcement Using Fibres Rather Than Fabric

A liquid composition was prepared by combining 10% by weight of carbon fibres into a blend of SE2 with a 60,000 mPas fluid at a ratio of 70:30. A slow high shear mixer was used. The liquid composition was poured into a flat mould and cured at 180° C. for 10 minutes. The results are shown in the following table.

### EN1621-1

| | Sheet | Sheet | 50 J impact | 50 J impact |
|---|---|---|---|---|
| % carbon | weight | thickness | 1 × sheets | 2 × sheets |
| fibre | (g/m²) | (mm) | (kN) | (kN) |
| 10 | 5,100 | 5.5 | 35 | 15 |

The carbon fibres had a length of ¼ inch (6.35 mm) and a diameter of 7 microns. Suitable suppliers are Toray Europe Ltd, SGL Technic Ltd, Toho Tenax Inc. and Hexcel Corporation

1. A composition comprising a mixture of:
(A) an elastomeric material having a modulus at 100% elongation of 0.1-10 MPa; and
(B) 5-80% by weight, based on the total weight of the composition of a non-reactive silicone fluid having a viscosity of 1,000-3,000,000 mPas at 25° C.

2. The composition as claimed in claim 1 comprising a mixture of wherein the elastomeric material is a cross-linked silicone elastomer.

3. The composition as claimed in claim 2, wherein component (A) is formed from the reaction product of (i) a curable polyorganosiloxane having at least 2 hydrolysable groups, (ii) a filler, and (iii) a curing package comprising a hydrolysable group-containing organosilane in the presence of a condensation catalyst.

4. A use The composition as claimed in claim 2, wherein component (A) is formed from the reaction product of component (i) an organopolysiloxane polymer having at least one alkenyl or alkynyl group per end group and optionally alkenyl or alkynyl groups linked to silicon atoms along the polymer backbone, component (ii) a filler and component (iii) a curing package comprising a siloxane cross-linker containing at least three Si—H groups per molecule and a hydrosilylation catalyst.

5. The composition as claimed in claim 4, wherein component (ii) is a silicone resin or a surface-treated silica.

6. The composition as claimed in claim 1, wherein the elastomer is a polyurethane elastomer.

7. The composition as claimed in claim 1, wherein component (B) has a viscosity of 5,000-1,000,000 mPas at 25° C.

8. The composition as claimed in claim 1, wherein component (B) is a polyorganosiloxane in which the organic substituents are alkyl and/or aryl groups.

9. The composition as claimed in claim 1, wherein component (B) is a polydimethylsiloxane.

10. An impact-resistant material comprising the composition as defined in claim 1.

11. The impact-resistant material as claimed in claim 10, further comprising a substrate, wherein the substrate is impregnated or coated with the composition.

12-13. (canceled)

14. The impact-resistant material as claimed in claim 11, wherein the substrate is selected from a fabric, a foam, or a combination thereof.

15. The impact-resistant material as claimed in claim 10 in the form of a sheet.

16-17. (canceled)

18. A shaped article formed partially or completely of the impact-resistant material as claimed in claim 10.

19. The impact-resistant material as claimed in claim 10, in the form of a foam.

20. A process for preparing the composition as claimed in claim 1, comprising forming component (A) in the presence of component (B).

21. A process for preparing the silicone composition as claimed in claim 2, comprising the steps of:
(A) mixing (i) a curable polyorganosiloxane, (ii) a reinforcing filler, (iii) a curing package and (B) a non-reactive silicone fluid having a viscosity of 1,000-3,000,000 mPas at 25° C.; and
(B) curing the resultant mixture.

22. The process as claimed in claim 21, wherein curing is performed by heating the resultant mixture.

23. The method of making an impact-resistant material comprising the step of treating a substrate with a composition as defined in claim 1, and curing said composition.

24-25. (canceled)
